(19) United States
(12) Patent Application Publication
(10) Pub. No.: US 2019/0311376 A1
(43) Pub. Date: Oct. 10, 2019

(54) ASSET OWNERSHIP TRACKING SYSTEM WITH VIRTUAL TAGGING AND METHOD OF USE

(71) Applicants: Michael Melcher, Honolulu, HI (US); Peter J. Melcher, Ithaca, NY (US); Kyle Bateman, Frisco, TX (US); Paul Burley, McKinney, TX (US)

(72) Inventors: Michael Melcher, Honolulu, HI (US); Peter J. Melcher, Ithaca, NY (US); Kyle Bateman, Frisco, TX (US); Paul Burley, McKinney, TX (US)

(21) Appl. No.: 16/288,643

(22) Filed: Feb. 28, 2019

Related U.S. Application Data
(60) Provisional application No. 62/654,060, filed on Apr. 6, 2018.

(51) Int. Cl. G06Q 30/00

(52) U.S. Cl. CPC G06Q 30/0185; G06Q 50/265

(57) ABSTRACT

A method and system of tracking ownership of an asset includes virtually tagging an asset through a smart device, wherein the virtual tagging assigns a unique identifier to the asset; receiving a first verification of ownership by receiving an identifying information of a first user; assigning the first verification of ownership to the virtual tag, thereby creating a log of ownership; receiving a second verification of ownership by receiving an identifying information of a second user; and assigning the second verification of ownership to the virtual tag, thereby adding to the log of ownership. Further, the method and system provides for a virtual notary system.

### BACKGROUND

### 1. Field of the Invention

The present invention relates generally to asset ownership tracking and transfer systems, and more specifically, to an asset ownership transfer and tracking system with virtual asset tagging and log creation of ownership associated with an asset.

### 2. Description of Related Art

Asset ownership tracking is well known in the art and is an effective means to determine proper ownership of an asset. For example, FIG. 1 depicts a flowchart 101 depicting conventional ownership tracking wherein a first owner purchases an asset, as shown with box 103. The first owner's rights are inherently created through the purchase or initial acquiring of the asset, the asset being any physical or virtual asset, or any other contractual arrangement. When the first user decides to sell or transfer ownership, a physical contract can be created to be signed by both parties, thereby designating the transfer of ownership, as shown with boxes 105, 107, 109.

One of the problems commonly associated with method 101 is limited tracking. For example, ownership tracking and logging may be lost due to the physical papers. Further, additional owners and parties do not always receive a record of ownership or persons involved. In addition, the method could benefit from streamlining, using virtual methods and modern technology.

Accordingly, although great strides have been made in the area of asset ownership tracking, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a conventional method of asset transfer of ownership;

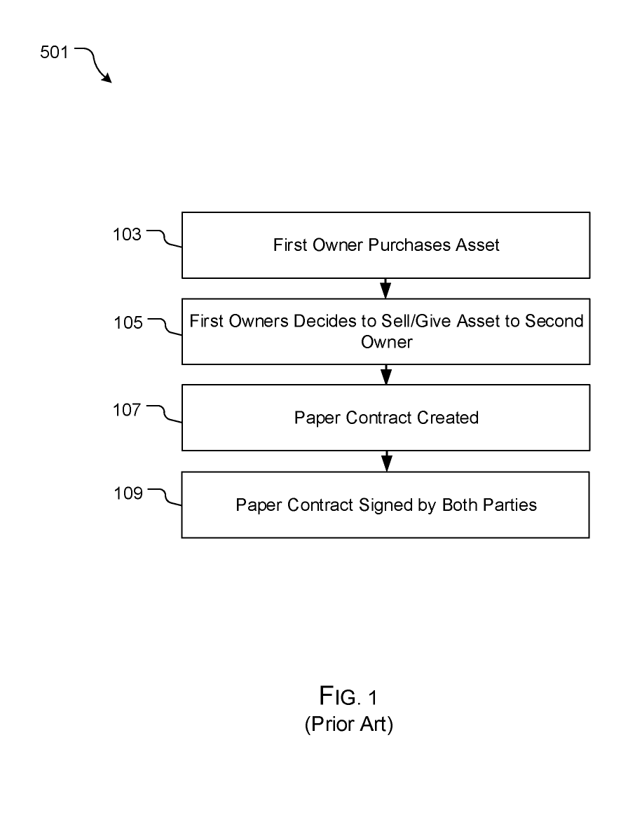

FIG. 2 is a simplified front view of a smart device of an asset ownership tracking system with virtual asset tagging in accordance with a preferred embodiment of the present application;

FIG. 3 is a simplified schematic of use of the smart device of FIG. 2 to tag a plurality of assets via a platform of FIG. 2;

FIG. 4 is a simplified schematic of a use of the smart device and platform of FIG. 2 to transfer of an asset in accordance with the system of the present invention;

FIG. 5 is a simplified schematic of the features of a platform of FIG. 2;

FIG. 6 is a flowchart depicting a method of asset transfer in accordance with the system of the present application; and

FIG. 7 is a flowchart of an alternative use of the system of the present application.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional asset transfer systems. Specifically, the present invention provides a system with virtual asset tagging to assign any asset, whether physical, virtual, or contractual in nature, with a unique ID, wherein ownership of the asset is virtually tracked and recorded via ownership verification. In addition, the present invention provides a means for two or more persons to consent to an interaction through a virtual contract, thereby allowing for improved communication between two or more persons, such as in the context of dating. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

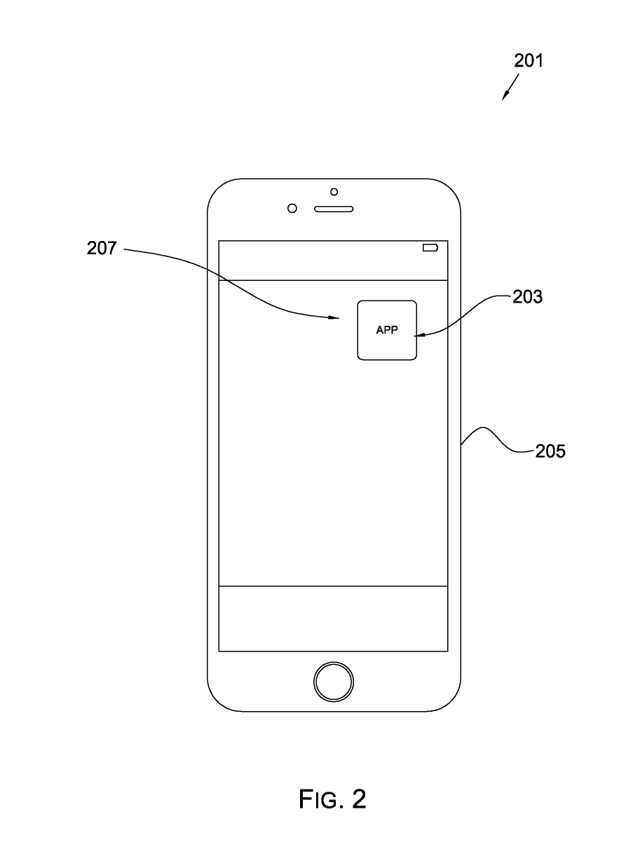

Referring now to the drawings wherein like reference characters identify corresponding or similar elements throughout the several views, FIGS. 2-7 depict various views of an asset ownership tracking system 201 with virtual tagging in accordance with a preferred embodiment of the present application. It will be appreciated that system 201 overcomes one or more of the above-listed problems commonly associated with conventional asset ownership transfer systems.

In the contemplated embodiment, system 201 includes a platform 203 accessible via a smart device 205, such as a mobile phone, tablet, portable computer, and the like. The smart device 205 includes at least a location determination technology, a camera, and a display 207. In the preferred embodiment, the display 207 is a touch screen, and/or other input/output device, configured to receive input such as hand gestors used with the Microsoft HoloLens, to be manipulated by the user.

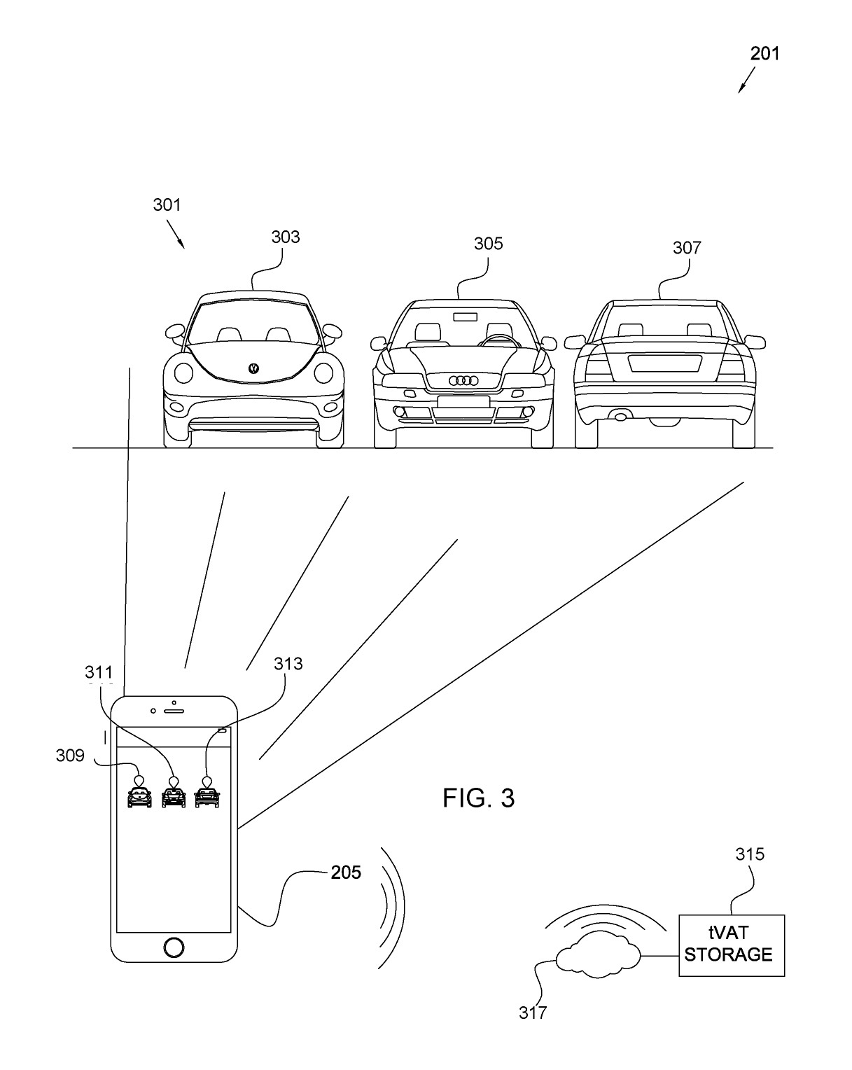

Platform 203 provides a means to virtually tag one or more assets, and further track ownership of the virtual assets. As shown in FIG. 3, in one embodiment, the assets 301 are physical assets, such as a plurality of vehicles 303, 305, 307, wherein each is assigned a unique ID to create a virtual tag 309, 311, 313, wherein data and information regarding each asset 303, 305, 307 is stored 315 via a cloud based server and/or network 317.

It must be understood that in the present application, an asset can be a physical good, such as vehicles, houses, appliances, jewelry, firearms, and any other good for which an individual or company may own. However, it should be appreciated that the assets could alternatively be intangible or virtual goods, such as monetary values, business ownership, intellectual property rights, etc. Further, as will be discussed in more detail below, the asset could be one of a contractual relationship between two or more parties, wherein a contract, and those who have agreed to and/or reviewed the contract can be tracked in a history of the contractual relationship.

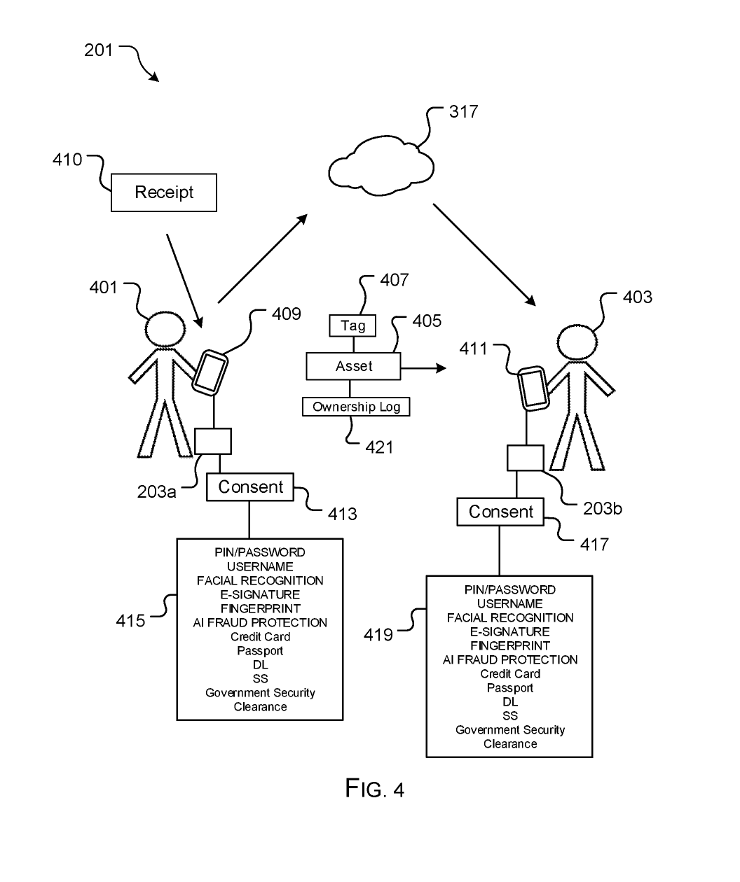

In FIG. 4, a simplified schematic depicts the use of system 201. In the preferred embodiment, two or more parties 401, 403 desire to transfer an asset 405 between them. This can be a loan of the asset, a transfer of 100% ownership, or any variation thereof. At the inception, the asset 405 is assigned a unique ID 407, thereby allowing for accurate tracking and logging. In some embodiments, when the first party 401 purchases the asset 405, the receipt 410 can be stored and saved within the platform 203. This could be achieved via the party providing their ID/username of the platform to a teller, or through manual entry. This feature allows for the proof of purchase (receipt 410) to virtually stay with the asset to be used by any future owner of the asset later on. Each party 401, 403 has access to platform 203a-b via smart devices 409, 411. Platform 203a is configured to receive consent 413 from first party 401, in the form of identification 415, wherein the consent 413 is logged. Similarly, second party 403 provides consent 417 in the form of identification 419, thereby making the transfer of ownership complete. The ownership history is logged 421 for the life of the asset 405. It should be appreciate that each owner further retains an asset archive relating to asset transfer records.

It should be appreciated that one of the unique features believed characteristic of the present application is virtual consenting of ownership transfer between multiple parties, thereby ensuring unambiguous ownership of the asset. In some embodiments, the consent is unanimous, thereby allowing for parties to protect their identity. It should be appreciated that the system remains secure via collecting personal identifying information and verifying each party via the identifying information. Such information can include, among others, a username, a password, fingerprint recognition via a scanner of the smart device, facial recognition via a camera of the smart device, electronic signatures, artificial intelligence fraud protection, credit card number input, government issued ID, passport, driver's license number, last 4 of social security numbers, government level of security clearance, top secret, secret, confidential, or any other known or future means in the art.

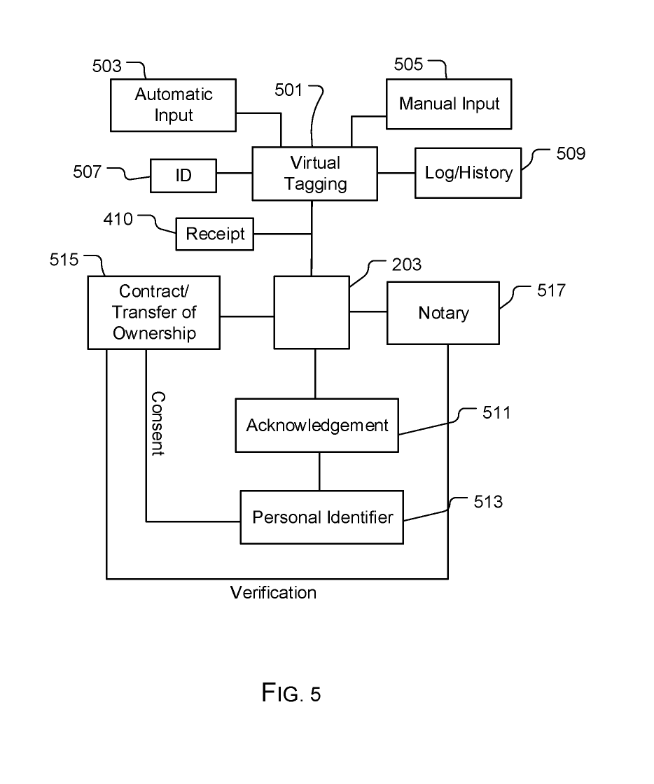

In FIG. 5, another simplified schematic depicts the features of platform 203. Platform 203 allows for the virtual tagging 501 of an asset, wherein the virtual tagging could be automatically created 503 such as through an input of a receipt, online purchase, scanning of a variety of codes, or the like. For a new purchase, the receipt 410 can be automatically saved within the platform as described above, thereby allowing for the transfer of the receipt between owners. Further, the virtual tagging 501 could be manually input 505 via the user, such as inputting a serial number, a value, a model, etc. relating to the asset. Each tag 501 correlates to a unique ID 507 and tracks a log/history 509 of the asset.

Upon the transfer/loaning/sharing of the asset, platform 203 is configured to receive acknowledgement 511 via one or more parties involved in the form of a personal identifier (as discussed above) 513. Such acknowledgement provides consent to a contract/transfer 515.

In some embodiments, platform 203 further includes a notary feature 517. Notary feature 517, provides for a notarized service to contractual arrangements, wherein the notary feature is certified for providing the notarizing service. This feature allows for user's to efficiently have contractual arrangements notarized.

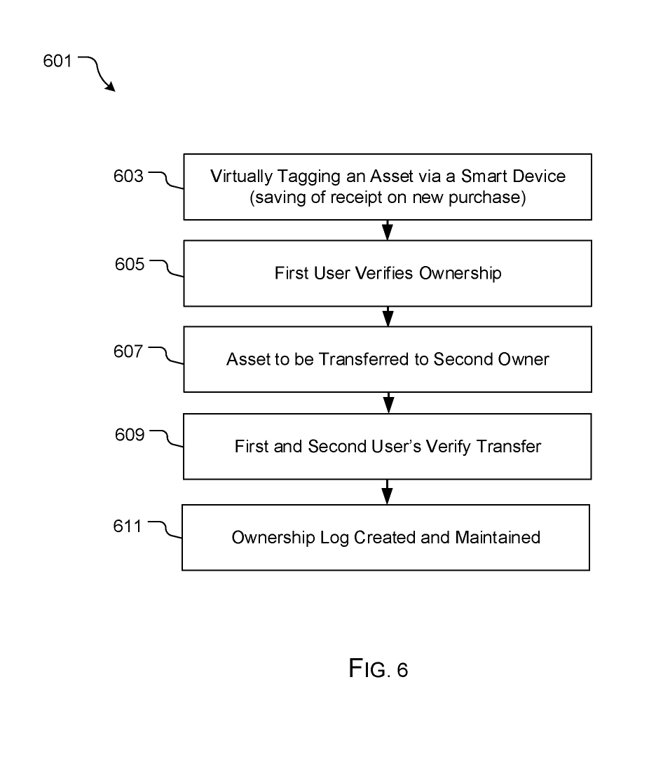

In FIG. 6, a flowchart depicts a first use of system 201. During use, an asset is virtually tagged wherein first ownership is recorded in a log, as shown with boxes 603, 607. As the asset is to be transferred to a second ownership, the parties provide consent via the platform, wherein ownership is further tracked and recorded, as shown with boxes 607, 609, 611.

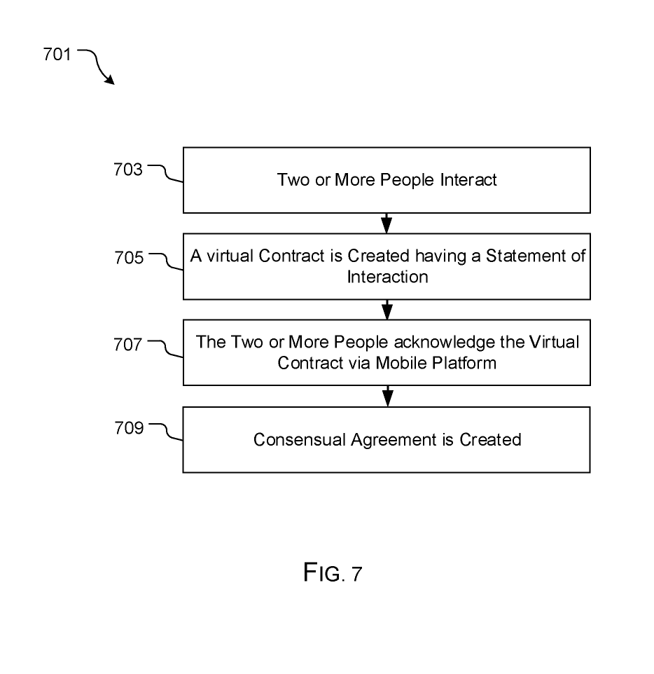

In FIG. 7, a second use of system 201 is shown. This use is particularly beneficial in personal interactions, such as dating, wherein consensual relationships are important to maintain. During use, when two or more persons interact, such as in a restaurant or bar, and the two or more persons decide to engage in an activity, such as a sexual activity, a virtual contract can be created via platform 203, as shown with boxes 703, 705. The virtual contract can be simple, merely stating that the party is consenting to a specified or general activity, or the contract can be complex, laying out the exact nature of what the party desires to consent to. The two or more parties provide acknowledgement of the contract through the platform via providing identifying information, as shown with box 707. A consensual agreement is thereby created between the two or more parties, which is retained within each parties history of transactions file, as shown with box 709.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An asset tracking system, comprising:
a smart device having a camera, a GPS, and a display;
a central server configured to communicate with the smart device to receive and store data;
a mobile platform accessible from the smart device, wherein the mobile platform is configured to:
store a virtual tag associated with an asset, the virtual tag having a unique identifier associated with the asset;
receive a first verification of ownership by receiving an identifying information of a first user;
assign the first verification of ownership to the virtual tag, thereby creating a log of ownership;
receive a second verification of ownership by receiving an identifying information of a second user; and
assign the second verification of ownership to the virtual tag, thereby adding to the log of ownership.

2. The system of claim 1, wherein the first verification of ownership is one or more of:
a username;
a fingerprint as determined via a fingerprint scanner of the smart device;
a facial recognition via the camera; and
a password.

3. The system of claim 1, wherein the mobile platform is further configured to:
track and assign a location to each of the first and second verification of ownership.

4. The system of claim 1, wherein the first verification of ownership comprises:
artificial intelligence fraud protection.

5. A method of tracking ownership of an asset, the method comprising:
virtually tagging an asset through a smart device, wherein the virtual tagging assigns a unique identifier to the asset;
receiving a first verification of ownership by receiving an identifying information of a first user;
assigning the first verification of ownership to the virtual tag, thereby creating a log of ownership;
receiving a second verification of ownership by receiving an identifying information of a second user; and
assigning the second verification of ownership to the virtual tag, thereby adding to the log of ownership.

6. The method of claim 5, further comprising:
tracking and assigning a location to each of the first and second verification of ownership.

7. The method of claim 1, further comprising:
saving a virtual receipt associated with the asset, the virtual receipt configured to be transferred between the first user and the second user.

8. A method of receiving consent from two or more persons, the method comprising:
providing a mobile platform accessible from one or more smart devices;
receiving identifying information from the two or more persons to create profiles associated with each to the two or more persons;
creating a virtual contract within the mobile platform accessible via the two or more persons, the virtual contract having a statement regarding an interaction between the two or more persons; and
receiving an acknowledgement of the virtual contract from the two or more persons, the acknowledgement creating a consensual agreement between the two or more persons;
wherein the acknowledgement is provided through the mobile platform.

9. The method of claim 8, wherein the identifying information comprises one or more of:
a username;
an electronic signature;
a fingerprint as determined via a fingerprint scanner of the smart device;
a facial recognition via the camera;
a password;
a passport;
a driver's license;
a last four of social security number; and
a government security clearance.

10. The method of claim 8, further comprising:
tracking and recording a location associated with the acknowledgment of the virtual contract for each of the two or more persons.
